(19) United States
(12) Patent Application Publication
(10) Pub. No.: US 2012/0072741 A1
(43) Pub. Date: Mar. 22, 2012

(54) COMPUTER SYSTEM, POWER SUPPLY APPARATUS AND CONTROL METHOD THEREOF

(75) Inventor: Seung-jae LEE, Seongnam-si (KR)

(73) Assignee: Samsung Electronics Co., Ltd, Suwon-si (KR)

(21) Appl. No.: 13/098,537

(22) Filed: May 2, 2011

(30) Foreign Application Priority Data
Sep. 17, 2010 (KR) 10-2010-0091590

(51) Int. Cl. G06F 1/26; H02M 3/335

(52) U.S. Cl. 713/300; 363/21.09

(57) ABSTRACT

A computer system includes at least one device, a connector which is connected to a power supply apparatus which supplies power having a predetermined level to operate the computer system, a power unit which converts and provides the power supplied from the power supply apparatus to the at least one device, and a controller which analyzes a signal waveform of power supplied from the power supply apparatus and identifies information of the power supply apparatus carried by the signal waveform. Accordingly, an abnormal operation of the computer system can be prevented by transmitting power information such as a power capacity of the power supply apparatus to the computer system.

### CROSS-REFERENCE TO RELATED APPLICATIONS

This application claims priority under 35 U.S.C. §119(a) from Korean Patent Application No. 10-2010-0091590, filed on Sep. 17, 2010 in the Korean Intellectual Property Office, the disclosure of which is incorporated herein by reference.

### BACKGROUND

1. Field of the Invention

An apparatus and method relate to a computer system, a power supply apparatus and a control method thereof, and more particularly, to a power supply apparatus which converts AC power to output DC power, and a computer system and a control method which uses the power supply apparatus as a power source.

2. Description of the Related Art

A computer system such as a notebook computer and a desktop computer operates by receiving power from a power supply apparatus such as an adaptor which converts AC power to output DC power.

The computer system should receive appropriate power to operate normally. The power supply apparatus may have power capacity available at various levels according to the purpose of design. If the computer system receives power from a power supply apparatus which fails to supply adequate power to operate the computer system, the computer system may malfunction and may not ensure normal operation.

Particularly, a typical computer system has a power supply apparatus that may be attached and/or detached thereto. If a user is not aware of the power capacity of a power supply apparatus, he/she may connect the power supply apparatus with inappropriate power capacity to the computer system. In that case, the computer system may operate abnormally.

### SUMMARY

Accordingly, one or more exemplary embodiments provide a computer system, a power supply apparatus and a control method thereof which prevents abnormal operation by transmitting power information such as a power capacity of the power supply apparatus to the computer system.

Another exemplary embodiment is to provide a computer system, a power supply apparatus and a control method thereof which has a simple configuration without changing a connector type in transmitting power information of the power supply apparatus to the computer system.

Additional features and utilities of the present general inventive concept will be set forth in part in the description which follows and, in part, will be obvious from the description, or may be learned by practice of the present general inventive concept.

The foregoing and/or other features may be achieved by providing a computer system including: at least one device; a connector which is connected to a power supply apparatus which supplies power having a predetermined level to operate the computer system; a power unit which converts and provides the power supplied from the power supply apparatus to the at least one device; and a controller which analyzes a signal waveform of power supplied from the power supply apparatus and identifies information of the power supply apparatus carried by the signal waveform.

The controller may identify the information of the power supply apparatus based on the number of a peak or a dip of the signal waveform during a predetermined time frame.

A deviation between the peak or the dip of the signal waveform and a reference value of the power may be within a predetermined stable range.

The controller may determine that the information of the power supply apparatus is valid when a supply of the power is initiated.

The at least one device may include a display unit, and the controller displays the information of the power supply apparatus on the display unit.

The information of the power supply apparatus may include information of a power capacity of the power supply apparatus, the at least one device may include a light emitter, and the controller may control the light emitter to flicker, i.e., blink, based on whether the power capacity of the power supply apparatus is within a predetermined normal range.

The information of the power supply apparatus may include information of a power capacity of the power supply apparatus, and the controller may control the at least one device not to operate if the power capacity of the power supply apparatus is out of a predetermined normal range.

Another feature may be achieved by providing a control method of a computer system which includes at least one device, the control method including: receiving power having a predetermined level from a power supply apparatus to operate the computer system; and analyzing a signal waveform of power supplied from the power supplying apparatus and identifying information of the power supply apparatus carried by the signal waveform.

The identifying may include identifying the information of the power supply apparatus based on the number of a peak or a dip of the signal waveform during a predetermined time frame.

A deviation between the peak or the dip of the signal waveform and a reference value of the power may be within a predetermined stable range.

The identifying may include identifying that the power information of the power supply apparatus is valid when a supply of the power is initiated.

The at last one device may include a display unit, the control method further including displaying the information of the power supply apparatus on the display unit.

The information of the power supply apparatus may include information of a power capacity of the power supply apparatus, and the at least one device may include a light emitter, the control method further including allowing the light emitter to flicker, i.e., blink, based on whether the power capacity of the power supply apparatus is within a predetermined normal range.

The information of the power supply apparatus may include information of the power capacity of the power supply apparatus, the control method further including controlling the at least one device not to operate if the power capacity of the power supply apparatus is out of the predetermined normal range.

Still another feature may be achieved by providing a power supply apparatus of a computer system, the power supply apparatus including: a converter which converts an input voltage into an output voltage for an operation of the computer system; an output unit which is connected to the computer system and outputs the output voltage; and a converter controller which controls the converter to make the output voltage reach a target value of a predetermined level and to modulate a signal waveform of the output voltage so as to carry information of the power supply apparatus to the computer system.

The converter controller may modulate the signal waveform of the output voltage so that the number of a peak or a dip of the signal waveform corresponds to the information of the power supply apparatus during a predetermined time frame.

A deviation between the peak or the dip of the signal waveform and a target value of the output voltage may be within a predetermined stable range.

The converter controller may modulate the signal waveform of the output voltage when an output of the output voltage is initiated.

The modulation of the signal waveform may be performed one time or repeatedly at an predetermined interval, and the converter controller may control the modulation of the signal waveform to be performed predetermined times or less from the time when the output of the output voltage is initiated.

Another feature of the present general inventive concept includes a A computer system, comprising a power supply apparatus to output a supply voltage signal reaching a predetermined target value and to module a signal waveform of the supply voltage to include power supply information of the power supply apparatus, and a computer apparatus to receive the supply voltage signal and to determine the power supply information of the supply voltage signal to control at least one device of the computer apparatus.

In another feature of the present general inventive concept, a power supply apparatus comprises a voltage converter module to convert a high voltage DC base signal into a low voltage DC supply signal having a predetermined voltage level, a feedback module to generate a feedback signal based on the low voltage DC supply signal, and a converter controller in communication with the feedback module to generate a converter control signal based on the feedback signal that modulates the low voltage DC supply signal to carry power information of the power supply apparatus and that maintains the low voltage DC supply signal at the predetermined voltage level.

In still another feature of the present general inventive concept, a mobile terminal apparatus comprises a power interface to be connected to a power supply that generates a supply voltage signal including power information of the power supply, a power information module that determines the power information from the supply voltage signal, and a control module in communication with the power information module that controls operation of the mobile terminal apparatus based on the determined power information.

In yet another feature of the present general inventive concept, a method of generating a supply voltage to operate a computer system comprises converting a high voltage DC base signal into a low voltage DC supply signal having a predetermined voltage level, generating a feedback signal based on the low voltage DC supply signal, modulating the low voltage DC supply signal based on the feedback signal to carry power information of the power supply apparatus, and maintaining the low voltage DC supply signal at the predetermined voltage level based on the feedback signal.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 illustrates an external appearance of a computer system according to an exemplary embodiment of the present general inventive concept;

FIG. 2 is a block diagram of the computer system in FIG. 1 and a power supply apparatus;

FIG. 3 is a circuit diagram of the power supply apparatus in FIG. 2;

FIG. 4 illustrates a waveform of a signal that is output by the power supply apparatus;

FIG. 5 is a flowchart of a control method of the computer system in FIGS. 1 to 3;

FIGS. 6 and 7 are circuit diagrams of another power supply apparatus in FIG. 2; and

FIG. 8 is flowchart illustrating a method of generating a supply voltage to operate a computer system according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

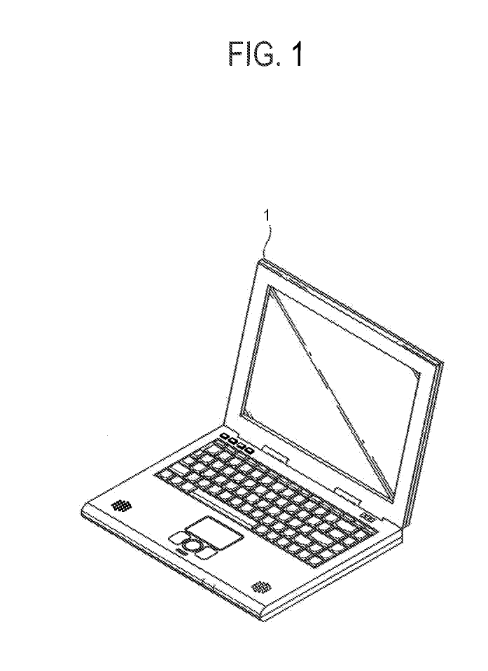

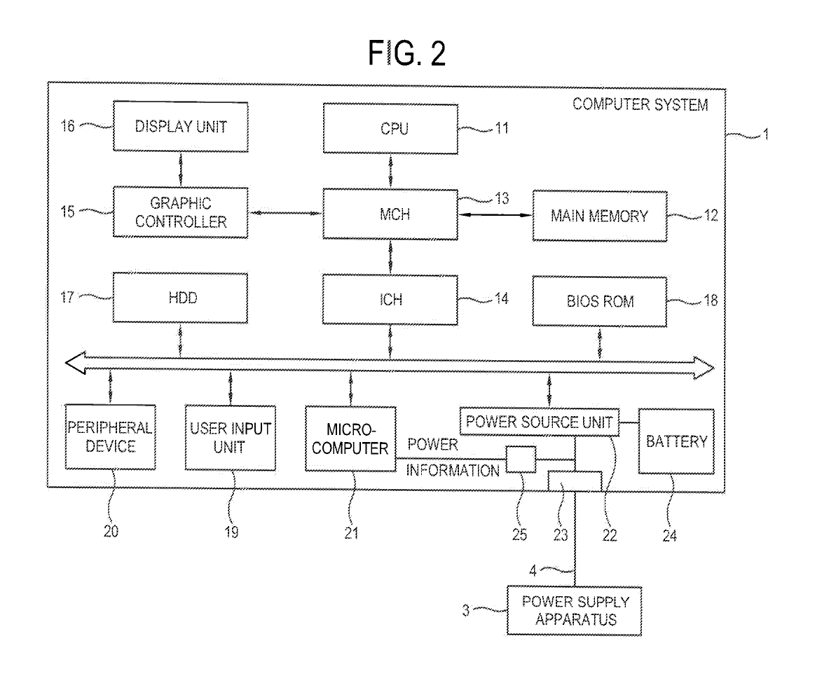

FIG. 1 illustrates an external appearance of a computer system 1 according to an exemplary embodiment of the present general inventive concept. It may be appreciated that although a laptop computer system is illustrated in FIG. 1, other various mobile terminal devices may be included. FIG. 2 is a block diagram of a configuration of the computer system 1 in FIG. 1 and a power supply apparatus 3. The computer system 1 operates by receiving power from the power supply apparatus 3 via a power interface 4. The power supply apparatus 3 converts received AC power into DC power and supplies such DC power to the computer system 1. FIG. 1 illustrates a notebook PC 1 as the computer system according to the exemplary embodiment of the present general inventive concept. However, the computer system 1 according to the exemplary embodiment of the present general inventive concept is not limited thereto and may include a desktop PC, etc.

Referring to FIG. 2, the computer system 1 includes at least one device that operates by receiving power from the power supply apparatus 3. More specifically, the computer system 1 may include a central processing unit (CPU) 11, a main memory 12, a memory controller hub (MCH) 13, an I/O controller hub (ICH) 14, a graphic controller 15 and a display unit 16.

The CPU 11 controls overall operations of the computer system 1, and executes a code of a computer program loaded upon the main memory 12.

The main memory 12 temporarily stores therein data relating to the performance of the operation of the CPU 11 including a computer program that is executed by the CPU 11. The main memory 12 is a volatile memory, and may include, e.g., a double-data-rate synchronous dynamic random access memory (DDR SDRAM).

The graphic controller 15 processes graphic data, and the display unit 16 displays an image thereon based on graphic data processed by the graphic controller 15. The display unit 16 may include a liquid crystal display (LCD) panel or an organic light emitting diode (OLED) panel.

The MCH 13 interfaces reading and writing of data between the CPU 11 and other elements, and the main memory 12. THE ICH 14 interfaces a communication between the CPU 11 and other devices (refer to reference numeral 19).

The computer system 1 may further include a hard disc drive (HDD) 17, a basic input/output system (BIOS) ROM 18, a user input unit 19 and a peripheral device 20.

The HDD 17 is a non-volatile memory which stores therein data in large quantity, and may store an operating system (OS) of the computer system 1, a device driver, an application program and a computer program operating in the computer system 1, and data necessary for the operation of such computer program and user's data. The HDD 17 may vary including a magnetic disk, a flash memory, etc.

The BIOS ROM 18 is a non-volatile memory such as a programmable read only memory (PROM), an electrically erasable programmable read only memory (EEPROM), and a flash memory, and stores therein a BIOS program performing booting and device-controlling operations and other functions.

The user input unit 19 is a device which receives a user's command, and may include, e.g., a keyboard, a mouse, a touch pad, a tablet and a touch screen.

The peripheral device 20 includes any device which may be built in the computer system 1 other than the above devices. For example, the peripheral device 20 may include a CD-ROM, a DVD-ROM, a USB drive, a modem, a network card, a sound card, a speaker, and a microphone. A single peripheral device 20 is illustrated in FIG. 2 for convenience, but the peripheral device 20 may be plural.

The computer system 1 may further include a connector 23 to receive power from the power supply apparatus 3, a power source unit 22 to convert power supplied by the power supply apparatus 3 through the connector 23 and to supply such converted power to the device, a battery 24 to supply charged battery power, and an information extracting/detecting unit 25. The connector 23 may be detachably connected to an output connector (not shown) of the power supply apparatus 3. The power source unit 22 may convert a first power supplied by the power supply apparatus 3 into an operating power. The conversion process of the power source unit 22 may include, but is not limited to, converting a high voltage base power that may be supplied by the power supply apparatus 3 into an operating power that may be stepped down to at a predetermined power level. Accordingly, the stepped down operating power may properly operate the computer system and may also charge the battery 24 of the computer system 24. The power supply apparatus 3 is described in greater detail below.

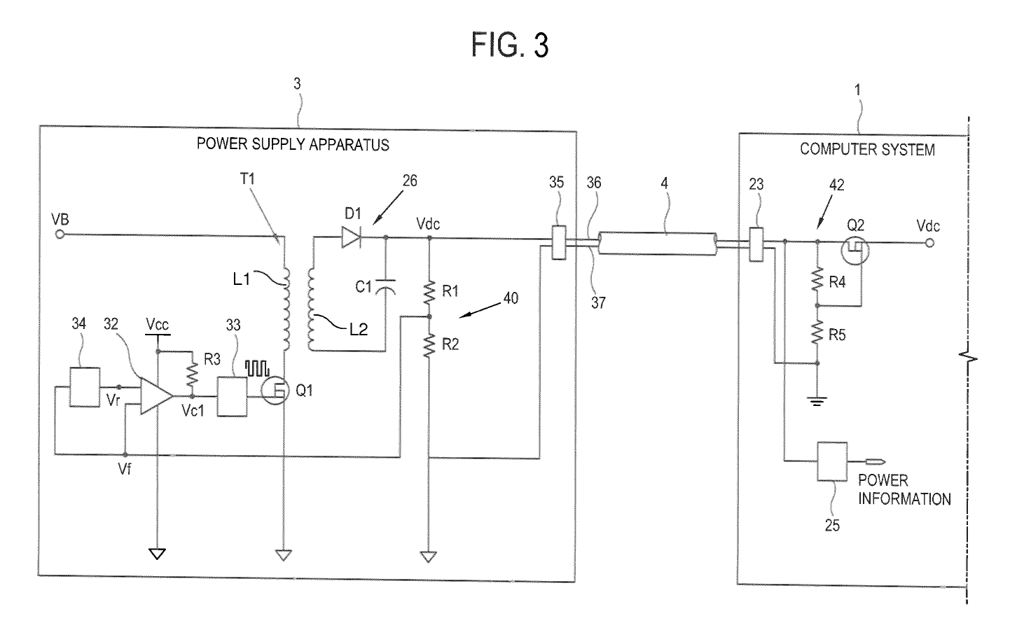

Referring to FIG. 3, a circuit diagram of a configuration of the power supply apparatus 3 of FIG. 2 is illustrated. The power supply apparatus 3 may include a rectifying and smoothing circuit (not shown) which receives, rectifies and filters alternating current (AC) power as commercial AC power and outputs a DC base voltage VB of approximately over 200V. As shown in FIG. 3, the power supply apparatus 3 converts the DV base voltage VB into a high-frequency square wave via a switching operation.

More specifically, the power supply apparatus 3 may include a voltage converter 26 convert the DC base voltage VB to a DC supply voltage Vdc having a voltage acceptable to operate the computer system 1. The DC base voltage VB may be a high voltage base voltage of 200V, and the DC supply voltage Vdc may be a low DC supply voltage stepped down from the DC base voltage VB having a voltage acceptable to operate the computer system 1. The voltage converter 26 may include a transformer T1 having a primary coil L1 and a secondary coil L2, a switching element Q1, a rectifying element D1, and a smoothing element C1. The transformer T1 outputs to the secondary coil L2 an induced voltage which is converted from the DC base voltage (VB) applied to the primary coil L1. The switching element Q1 is selectively switched on and off to flow a current to the primary coil L1 of the transformer T1. The rectifying element D1 rectifies the induced voltage output to the secondary coil of the transformer T1. The smoothing element, such as for example a capacitor C1 makes an output of the rectifying element D1 smooth, for example by removing noise from the output of the rectifying element D1, to generate a DC supply voltage Vdc. Accordingly, an output terminal 35 outputs the DC supply voltage Vdc to the computer system 1.

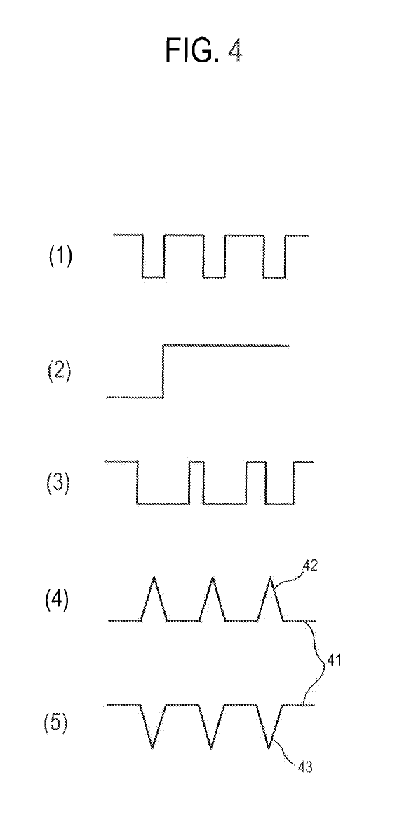

Reference numerals 36 and 37 in FIG. 3 indicate an output line 36 and a ground line 37, respectively, of the DC supply voltage Vdc. The power supply apparatus 3 may further include a feedback unit 40. The feedback unit 40 includes a first resistor R1 and a second resistor R2 which generate a feedback signal Vf of the DC supply voltage Vdc. The power supply apparatus 3 may further include a first comparator 32 which compares the feedback signal Vf to a reference signal Vr, shown for example as waveform (1) in FIG. 4. The reference signal Vr is described in greater detail below.

Accordingly, when the comparator 32 determines that the feedback signal Vf is equal to or below the reference signal Vr, the comparator 32 outputs a first comparison result signal Vc1 having a HIGH voltage state value, as shown in waveform (2) of FIG. 4. A switch controller 33 is in communication with the comparator 32 and receives that first comparison result signal Vc1, and outputs a control signal that controls the switching element Q1 to output the DC supply voltage Vdc. Thus, since the switching element Q1 is activated when the first comparison result signal Vc1 exists in the HIGH voltage state, i.e., when the feedback signal Vf is equal to or below the reference signal Vr, the DC supply voltage Vdc may be maintained at a predetermined target voltage value that properly operates the computer system 1. The switch controller 33 may adjust a level of the DC voltage Vdc by pulse width modulation. Waveform (3) shown in FIG. 4 refers to an example of a waveform of the control signal output by the switch controller 33.

The power supply apparatus 3 may further include a reference signal generator 34 which outputs the reference signal Vr discussed above. The reference signal generator 34 outputs the reference signal Vr in consideration of the following two conditions that: (i) the reference signal Vr corresponds to a target value of the DC supply voltage Vdc, and (ii) the reference signal Vr corresponds to power information of the power supply apparatus 3. In the former case, the reference signal generator 34 outputs a reference signal Vr at a consistent level according to the target value of the DC voltage Vdc. In the latter case, the reference signal generator 34 outputs a reference signal Vr to modulate a signal waveform of the DC supply voltage Vdc so as to carry the power information of the power supply apparatus 3. For example, waveform (4) and waveform (5) shown in FIG. 4 illustrate two examples of a signal waveform of the DC supply voltage Vdc. The reference signal Vr may be set to make the signal waveform of the DC supply voltage Vdc repeat a peak 42 and a dip 43, as illustrated in waveforms (4) and (5) shown in FIG. 4, based on a target value 41. For reliability of the operation, a deviation between the peak 42 or the dip 43 and the target value 41 of the DC supply voltage Vdc may be within a predetermined stable range. For example, the stable range of the deviation may be approximately 20% or less of the target value 41 of the DC supply voltage Vdc.

The power information according to the present exemplary embodiment includes information of power properties of the power supply apparatus 3, including but not limited to power capacity. The power information of the power supply apparatus 3 may correspond to the number of peaks 42 or dips 43 existing during a predetermined time frame of the signal waveform of the DC supply voltage Vdc. For example, depending on the number of peaks 42 or dips 43, the power capacity of the power supply apparatus 3 may be 40 W, 60 W, 90 W, etc. The number of peaks 42 or dips 43 may be a couple of or several dozens of peaks or dips per minute.

The transformer T1, the switching element Q1, the rectifying element D1 and the smoothing element C1 in FIG. 3 are an example of a voltage converter 26, and the first resistor R1 and the second resistor R2 are an example of a feedback unit 40. The first comparator 32, the switch controller 33 and the reference signal generator 34 are an example of a converter controller to control the output of the DC supply voltage Vdc. It may be appreciated, however, that alternative variations of the voltage converter 26, the feedback unit 40 and the converter controller may be utilized to control and/or maintain the DC supply voltage Vdc to the computer system 1.

Referring to FIG. 3, the DC supply voltage Vdc supplied by the power supply apparatus 3 is supplied to the power source unit 22 of the computer system 1. The computer system 1 may further include a protection circuit 42 including resistor R4, resistor R5 and a cut-off switch Q2 to protect the computer system 1 by blocking the supply of the DC supply voltage Vdc if the DC supply voltage Vdc supplied by the power supply apparatus 3 is an over-voltage.

The computer system 1 may further include an information extracting/detecting unit 25 which analyzes a signal waveform of the DC supply voltage Vdc supplied by the power supply apparatus 3 and detects and/or extracts power information of the power supply apparatus 3 from the signal waveform, and a microcomputer 21 which controls the operation of the device of the computer system 1 based on the power information of the power supply apparatus 3. For example, the information extracting/detecting unit 25 may detect and/or extract the power information by counting the number of peaks 42 or dips 43 over a predetermined time frame of the signal waveform of the DC supply voltage Vdc. The information extracting/detecting unit 25 may transmit to the microcomputer 21 the power information of the power supply apparatus 3 which based on a result of the detection and/or extraction.

The information extracting/detecting unit 25 and/or the microcomputer 21 may identify that the power information of the power supply apparatus 3 is valid when the supply of the DC supply voltage Vdc is initiated. Once the power information of the power supply apparatus 3 is identified, the information extracting/detecting unit 25 or the microcomputer 21 may determine that the already-identified power information continues to be valid until the supply of the DC supply voltage Vdc is suspended. Alternatively, the information extracting/detecting unit 25 and/or the microcomputer 21 may identify that the power information of the power supply apparatus 3 is valid only when the supply of the DC supply voltage Vdc is initiated. Then, even if a configuration for preventing malfunction due to the change in the DC supply voltage Vdc in the power supply apparatus 3 is not additionally provided (to be described later in more detail), such malfunction may be minimized.

The microcomputer 21 controls one or more operations of the device based on the extracted power information of the power supply apparatus 3 received from the information extracting/detecting unit 25. The operations may include an alarm or alert that alerts a user of the computer system 1 that the power supply apparatus 3 having inappropriate power capacity is connected to the computer system 1. For example, the microcomputer 21 may display on the display unit 16 the power information of the power supply apparatus 3 as an alarm message to be understood by a user. Then, if the power supply apparatus 3 having inappropriate power capacity is connected to the computer system 1 and the microcomputer 21 displays the alarm message, a user may recognize that the connection is not correct.

In addition, the information extracting/detecting unit 25 and/or microcomputer 21 may include memory that may store the detected power information that is detected and/or extracted. The power information may include previous and/or required power information for properly operating the computer system 1. Accordingly, the information extracting/detecting unit 25 and/or microcomputer 21 may compare stored power information with the detected and/or extracted power information of the power supply apparatus 3.

As an another example, the computer system 1 may further include a light emitter (not shown) such as a light emitting diode (LED) to show appropriateness or inappropriateness of the power capacity of the power supply apparatus 3, and the microcomputer 21 may allow the light emitter to flicker, i.e., blink, based on whether the power capacity of the power supply apparatus 3 identified from the power information is within the predetermined normal range.

As an another example, the microcomputer 21 may perform a control operation such as cutting off the power supply so that at least one device does not operate if the power capacity of the power supply apparatus 3 identified from the power information is out of the predetermined normal range.

As discussed above, the power supply apparatus 3 according to the exemplary embodiment of the present general inventive concept transmits the DC supply voltage Vdc together with the power information of the power supply apparatus 3. Accordingly, the power information of the power supply apparatus 3 is transmitted by a simple configuration to the computer system 1, and abnormal operation due to inconsistency with the power properties of the computer system 1 may be efficiently prevented.

Compared to the transmission of the power information of the power supply apparatus 3 through an additional interface, the power supply apparatus 3 may transmit the power information to the computer system 1 through a minor changed configuration without changing a typical connector type.

The microcomputer 21 and the information extracting/detecting unit 25 which are described with reference to FIGS. 2 to 4 are an example of a controller of the computer system 1 according to the exemplary embodiment of the present general inventive concept.

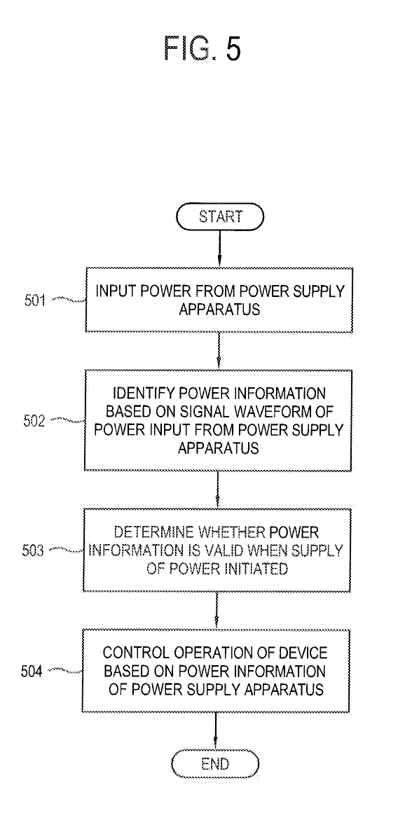

FIG. 5 is a flowchart of a control method of the computer system 1 according to the exemplary embodiment of the present general inventive concept. At operation 501, the power supply apparatus 3 supplies power to the device for operation.

At operation 502, the power information of the power supply apparatus 3 is identified on the basis of the signal waveform of the power generated by the power supply apparatus 3. For example, the power information may be identified on the basis of the number of peaks 42 or dips 43 of the signal waveform of the power input during the predetermined time frame.

At operation 503, when the supply of power is initiated, the power information of the power supply apparatus 3 may be determined to be valid.

At operation 504, the operation of the device is controlled based on the identified power information of the power supply apparatus 3. For example, the power information of the power supply apparatus 3 may also be displayed on the display unit 16. Additionally, the light emitter may flicker, i.e., blink, based on whether the power capacity of the power supply apparatus 3 identified on the basis of the power information is within the predetermined normal range. Also, if the power capacity of the power supply apparatus 3 identified on the basis of the power information is out of the predetermined normal range, operation of at least one device of the computer system 1 may be halted.

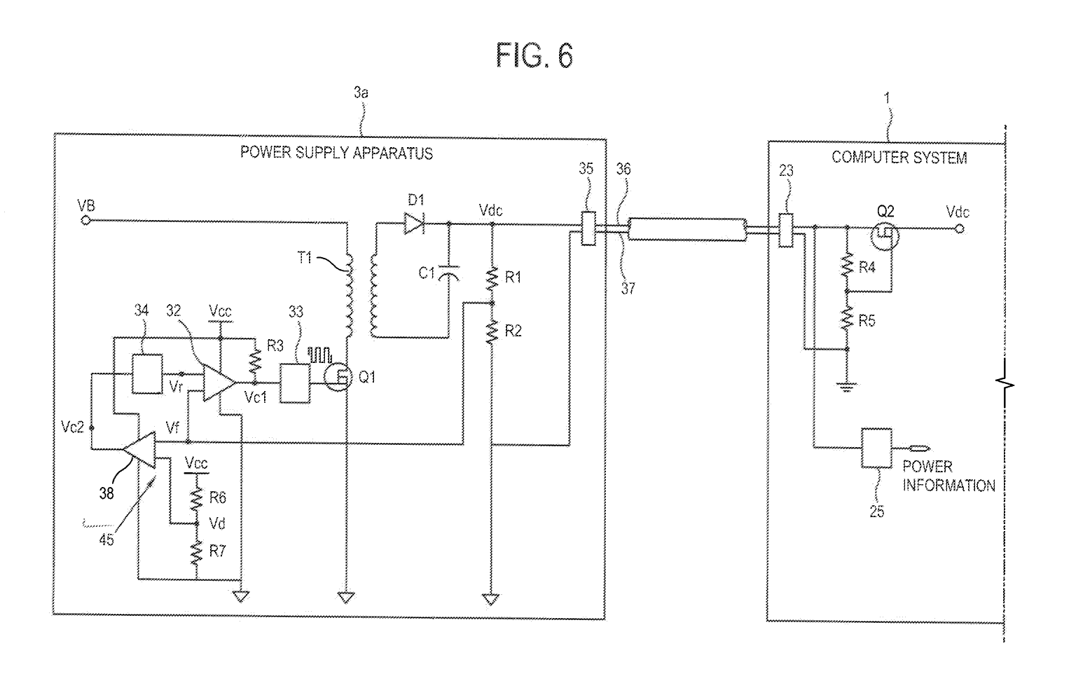

FIG. 6 is a circuit diagram of a configuration of a power supply apparatus 3a according to another exemplary embodiment of the present general inventive concept. The configuration of the power supply apparatus 3a which is similar to that of the power supply apparatus 3 described above with reference to FIGS. 2 to 4 will not be described again. The power supply apparatus 3a of FIG. 6, however, includes a supply voltage distortion prevention module 45 that may prevent deterioration of a reliability of the DC supply voltage Vdc More specifically, a DC supply voltage Vdc may change depending on a load of the computer system 1, and such change may cause a distortion of transmission of power information as if the signal waveform of the DC supply voltage Vdc has a peak or a dip. To prevent such distortion, the power supply apparatus 3a may further include sixth and seventh resistors R6 and R7, and a second comparator 38 which outputs a second comparison result signal Vc2 as a comparison result of a feedback signal Vf and a distribution voltage Vd. The distribution voltage Vd is generally a predetermined threshold voltage generated according to predetermined values of the resistors R6 and R7.

The second comparator 38 changes a level of the second comparison result signal Vc2 if the DC supply voltage Vdc reaches a target value after the power supply apparatus 3a initiates its operation. That is, the comparator 38 receives the feedback voltage Vf and the distribution voltage Vd, and outputs the second comparison result signal Vc2 when the feedback voltage Vf is equal to or less than the distribution Vd such that an accurate reference signal Vr generated by the reference signal generator 34 is maintained. Accordingly, the reference signal generator 34 of the power supply apparatus 3a outputs the reference signal Vr to modulate the DC supply voltage Vdc a predetermined number of times or less during the unit time frame. The DC supply voltage dc is modulated with the power supply information until the level of the second comparison result signal Vc2 is changed after the initiation of the operation of the power supply apparatus 3a. For example, the modulation of the DC supply voltage Vdc may be performed only once when the output of the DC supply voltage Vdc is initiated. The initiation of the output of the DC supply voltage Vdc includes connection of the power supply apparatus 3a to the computer system 1, and the initiation of the supply of AC power. As discussed above, by minimizing the number of modulations of the DC voltage supply Vdc, deterioration of a reliability of the DC supply voltage Vdc may be prevented.

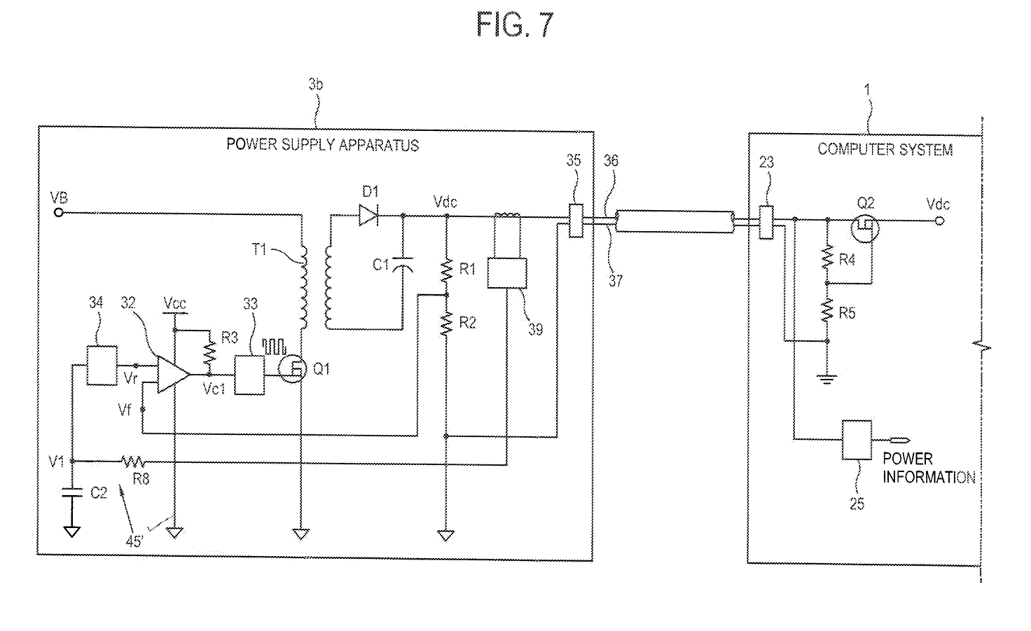

FIG. 7 is a circuit diagram of a configuration of a power supply apparatus 3b according to another exemplary embodiment of the present general inventive concept. The configuration of the power supply apparatus 3b which is the same or similar to that of the power supply apparatuses 3 and 3a described above with reference to FIGS. 2 to 5 will not be described again.

The power supply apparatus 3b further includes a current sensor 39 which detects a current flowing through an output terminal 35. Additionally, a supply voltage distortion prevention module 45′ may include an eighth resistor R8 may be connected to the current sensor 39 and a capacitor C2 to regulate a voltage V1 input to a reference signal generator 34 upon initial operation i.e., when the power supply apparatus 3a is initially connected to the computer system 1. More specifically, the capacitor C2 receives the voltage V1 and regulates the voltage V1 input to the reference signal generator 34. More specifically, the capacitor C2 controls the voltage V1 to gradually increase while the DC voltage Vdc reaches a target value after the power supply apparatus 3a initiates its operation. A reference signal generator 34 of the power supply apparatus 3b outputs a reference signal Vr to modulate the DC supply voltage Vdc a predetermined number of times or less, until the voltage V1 applied to the capacitor C2 reaches the predetermined value. Accordingly, distorted peaks and/or dips may be prevented from occurring in the DC supply voltage Vdc.

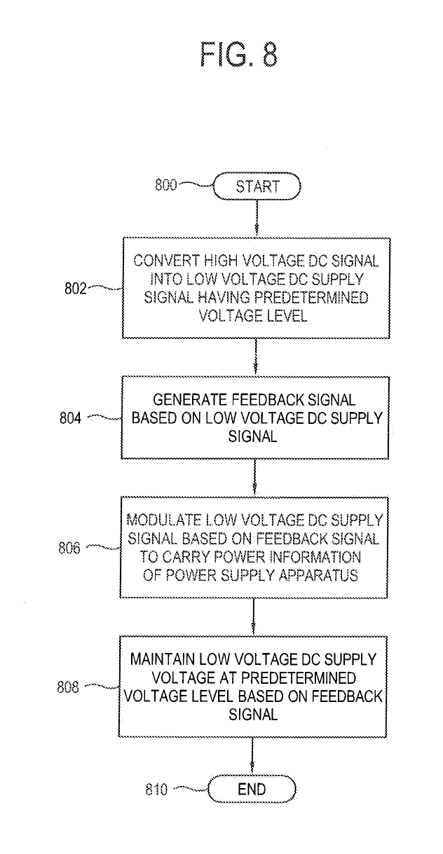

Referring now to FIG. 8, a flowchart illustrates a method of generating a supply voltage to operate a computer system 1. The method begins at operation 800, and proceeds to operation 802 where a high voltage DC base signal (VB) is converted into a low voltage DC supply signal (Vdc) having a predetermined voltage level. In operation 804, a feedback signal (Vf) is generated based on the low voltage DC supply signal (Vdc). Proceeding to operation 806, the low voltage DC supply signal (Vdc) is modulated based on the feedback signal (Vf) to carry power information of the power supply apparatus 3. In operation 808, the voltage level of low voltage DC supply signal (Vdc) is maintained at the predetermined voltage level based on the feedback signal (Vf), and the method ends at operation 810.

As described above, a computer system, a power supply apparatus and a control method thereof according to the present general inventive concept transmits power information such as a power capacity of the power supply apparatus to the computer system to thereby prevent an abnormal operation of the computer system.

Also, a computer system, a power supply apparatus and a control method thereof according to the present general inventive concept transmits power information of the power supply apparatus to the computer system through a simple configuration without changing a connector type.

Although a few exemplary embodiments of the present general inventive concept have been shown and described, it will be appreciated by those skilled in the art that changes may be made in these exemplary embodiments without departing from the principles and spirit of the general inventive concept, the range of which is defined in the appended claims and their equivalents.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

What is claimed is:

1. A computer apparatus comprising:
at least one device;
a connector which is connected to a power supply apparatus that supplies power having a predetermined level to operate the computer system;
a power unit that converts and provides the power supplied from the power supply apparatus to the at least one device; and
a controller that analyzes a signal waveform of power supplied from the power supply apparatus and identifies information of the power supply apparatus carried by the signal waveform.

2. The computer apparatus according to claim 1, wherein the controller identifies the information of the power supply apparatus based on a number of at least one of peaks and dips of the signal waveform during a predetermined time frame.

3. The computer apparatus according to claim 2, wherein a deviation between at least one of a peak and a dip of the signal waveform and a reference value of the power is within a predetermined stable range.

4. The computer apparatus according to claim 1, wherein the controller determines that the information of the power supply apparatus is valid when a supply of the power is initiated.

5. The computer apparatus according to claim 1, wherein the at least one device comprises a display unit, and the controller displays the information of the power supply apparatus on the display unit.

6. The computer apparatus according to claim 1, wherein the information of the power supply apparatus comprises information of a power capacity of the power supply apparatus, the at least one device comprises a light emitter, and the controller controls the light emitter to flicker based on whether the power capacity of the power supply apparatus is within a predetermined normal range.

7. The computer apparatus according to claim 1, wherein the information of the power supply apparatus comprises information of a power capacity of the power supply apparatus, and the controller halts operation of the at least one device when the power capacity of the power supply apparatus is out of a predetermined normal range.

8. A control method of a computer apparatus which comprises at least one device, the control method comprising:
receiving power having a predetermined level from a power supply apparatus to operate the computer system; and
analyzing a signal waveform of power supplied from the power supplying apparatus and identifying information of the power supply apparatus carried by the signal waveform.

9. The control method according to claim 8, wherein the identifying comprises identifying the information of the power supply apparatus based on a number of at least one of peaks and dips of the signal waveform during a predetermined time frame.

10. The control method according to claim 9, wherein a deviation between at least one of a peak and a dip of the signal waveform and a reference value of the power is within a predetermined stable range.

11. The control method according to claim 8, wherein the identifying comprises identifying that the power information of the power supply apparatus is valid when a supply of the power is initiated.

12. The control method according to claim 8, wherein the at last one device comprises a display unit,
the control method further comprising displaying the information of the power supply apparatus on the display unit.

13. The control method according to claim 8, wherein the information of the power supply apparatus comprises information of a power capacity of the power supply apparatus, and
the at least one device comprises a light emitter,
the control method further comprising allowing the light emitter to flicker based on whether the power capacity of the power supply apparatus is within a predetermined normal range.

14. The control method according to claim 8, wherein the information of the power supply apparatus comprises information of the power capacity of the power supply apparatus,
the control method further comprising controlling the at least one device not to operate if the power capacity of the power supply apparatus is out of the predetermined normal range.

15. A power supply apparatus of a computer system, the power supply apparatus comprising:
a converter which converts an input voltage into an output voltage for an operation of the computer apparatus;
an output unit which is connected to the computer system and outputs the output voltage; and
a converter controller which controls the converter to make the output voltage reach a target value of a predetermined level and to modulate a signal waveform of the output voltage so as to carry information of the power supply apparatus to the computer system.

16. The power supply apparatus according to claim 15, wherein the converter controller modulates the signal waveform of the output voltage so that a number of at least one of peaks or dips of the signal waveform is based on the information of the power supply apparatus during a predetermined time frame.

17. The power supply apparatus according to claim 16, wherein a deviation between at least one of a peak and a dip of the signal waveform and a target value of the output voltage is within a predetermined stable range.

18. The power supply apparatus according to claim 15, wherein the converter controller modulates the signal waveform of the output voltage when an output of the output voltage is initiated.

19. The power supply apparatus according to claim 18, wherein the modulation of the signal waveform is performed at least one of a single time and repeated times at a predetermined interval, and the converter controller controls the modulation of the signal waveform to be performed a predetermined number of times or less from the time when the output of the output voltage is initiated.

20. A computer system, comprising:
a power supply apparatus to output a supply voltage signal reaching a predetermined target value and to module a signal waveform of the supply voltage to include power supply information of the power supply apparatus; and
a computer apparatus to receive the supply voltage signal and to determine the power supply information of the supply voltage signal to control at least one device of the computer apparatus.

21. A power supply apparatus to receive an input voltage and converts the input voltage into a supply voltage signal having a predetermined voltage level and to modulate a signal waveform of the supply voltage to include power supply information of the power supply apparatus.

22. The power supply apparatus of claim 21, further comprising:
a voltage converter module to convert a high voltage DC base signal into a low voltage DC supply signal having a predetermined voltage level;
a feedback module to generate a feedback signal based on the low voltage DC supply signal; and
a converter controller in communication with the feedback module to generate a converter control signal based on the feedback signal to modulate the low voltage DC supply signal to carry the power information of the power supply apparatus and to maintain the low voltage DC supply signal at the predetermined voltage level.

23. The power supply apparatus of claim 22, further comprising a supply voltage distortion prevention module in communication with the feedback module and the converter controller to receive the feedback signal and to output a corrected voltage signal to the converter controller.

24. The power supply apparatus of claim 23, wherein the supply voltage distortion prevention module includes a distribution voltage module to generate a distribution voltage and a deviation comparator that compares a voltage of the feedback signal with the distribution voltage and that outputs the corrected voltage signal when the voltage of feedback signal is at least one of equal to or less than the distribution voltage.

25. The power supply apparatus of claim 23, wherein the supply voltage distortion prevention module includes a regulation capacitor in communication with the feedback module to generate the corrected voltage signal that gradually increases to a voltage level of the feedback signal.

26. A computer apparatus to receive a supply voltage signal including power information of a power supply apparatus and to determine the power supply information of the supply voltage signal to control at least one device of the computer apparatus.

27. The computer apparatus of claim 26, further comprising:
a power interface to be connected to a power supply that generates the supply voltage signal including the power information of the power supply;
a power information module that determines the power information from the supply voltage signal; and
a control module in communication with the power information module that controls operation of the mobile terminal apparatus based on the determined power information.

28. The computer apparatus of claim 27, wherein the operation controlled by the control module includes initiating an alert indicator indicating that the power supply is incompatible with the mobile terminal apparatus.

29. The computer apparatus of claim 28, wherein the alert indicator includes at least one of a displaying a warning on a display unit of the mobile terminal apparatus, lighting a light emitting device and sounding an alert sound via a sound output device.

30. A method of generating a supply voltage to operate a computer system, the method comprising:
converting a high voltage DC base signal into a low voltage DC supply signal having a predetermined voltage level;
generating a feedback signal based on the low voltage DC supply signal;
modulating the low voltage DC supply signal based on the feedback signal to carry power information of the power supply apparatus; and
maintaining the low voltage DC supply signal at the predetermined voltage level based on the feedback signal.
